(19) United States
(12) Patent Application Publication
(10) Pub. No.: US 2010/0054176 A1
(43) Pub. Date: Mar. 4, 2010

(54) SATELLITE ROUTING SYSTEM TO EXPEDITE COMPUTING PROCESSES

(76) Inventors: Gene Fein, Malibu, CA (US); Edward Merritt, Lenox, MA (US)

Correspondence Address: TAFT, STETTINIUS & HOLLISTER LLP, SUITE 1800, 425 WALNUT STREET, CINCINNATI, OH, 45202-3957, US

(21) Appl. No.: 12/202,283

(22) Filed: Aug. 31, 2008

(51) Int. Cl. H04B 7/185

(52) U.S. Cl. 370/316

(57) ABSTRACT

A communications routing system for transferring data from satellites to a computing resource. Embodiments include a group of satellites adapted to transfer data to a central satellite which transfers the data to a central computing device via a downlink. An exemplary system includes a central computing device running middleware which is operative to interface with a cloud computing resource and a client computing device.

### BACKGROUND

This disclosure relates generally to the field of communications systems involving satellites and, more particularly, to a satellite communications system that streamlines the downlink process from a group of satellites so that information is efficiently delivered to a downlink location in communication with a computing device, such as a cloud computing device.

It is well known that satellites are used to receive arid transmit data. Satellites are positioned & deployed all over space above the earth and beyond. A listing of many deployed satellites can be found via http://www.geo-orbit.org/. Satellites are particularly useful for communication when there is direct path between the downlink or uplink site and the satellite. When a satellite does hot have a direct, unobstructed signal path either to or from the satellite, the satellite may provide no transmission from point to point or limited transmission reliability. Currently, the systems to distribute information via satellite utilize various strategies. Large satellite communication systems, like those used by satellite television providers (such as DIRECTV), utilize many satellites so that their audience across the U.S. and beyond can have as many direct access points to satellites as needed to serve a geographically dispersed audience. Additional satellites also enable more data and service options for companies like DIRECTV who supply their users with many content options. In order to deliver content to an ultimate destination point, a single satellite that contains useful information may relay that information in real time to another satellite, whose position is more direct to a downlink position to enable that communication.

Communications between satellites may be accomplished using lasers, for example. In some systems, one satellite activates an optical beacon to scan the area where another satellite is expected to be. Once contact has been made, the second satellite responds by directing its own laser beam at the first satellite. Upon receiving the second satellite's beam, the first satellite stops scanning and an optical link is maintained for a pre-programmed period of time. See, e.g., European Space Agency Press Release No. 69-2001 entitled “A world first: data transmission between European satellites using laser light” and dated Nov. 22, 2001, which is incorporated by reference. See also U.S. Pat. No. 5,262,790 and EP 0 482 472, which are incorporated by reference.

Currently, the most common method for communicating data from different satellites is to use multiple downlink locations, then communicate the data terrestrially using wireless or wired connections to a single gathering point where all data points may be combined, accrued and organized for use and or comparative consumption.

Conventional models of exchanging data between or among satellites use onboard switching matrix systems to utilize 3 or more satellites to cover the entire globe. These satellite systems are used for banking information as well as broadcasting and television systems. For example, the BANKIR system is used for communicating banking information. See Koutoukov, V. and Stolyar D., “BANKIR” Satellite Communication System, Proceedings of International Conference on Satellite Communications, Volume 2, pp. 183-89, October 1994, which is incorporated by reference.

### BRIEF SUMMARY

Embodiments disclosed herein may provide a communications routing system for transferring data from satellites to a computing resource. Embodiments include a group of satellites adapted to transfer data to a central satellite which transfers the data to a central computing device via a downlink. The central computing device may include middleware operative to interface with a cloud computing resource.

In one aspect, a method for processing data gathered by satellites may include receiving, by a middleware, object data collected by a central satellite from a plurality of data-gathering satellites; and channeling the object data by the middleware to a computing cloud for processing.

In another aspect, a method for processing data utilizing satellites may include receiving, by a central satellite, object data transmitted from a plurality of data-gathering satellites; and downloading the object data, by the central satellite, to a downlink point for processing.

In another aspect, a method for processing data utilizing satellites may include uploading object data from a plurality of data sources to a plurality of data-gathering satellites; transmitting the object data from the data-gathering satellites to a central satellite; downloading the object data from the central satellite to a downlink point; and processing the object data downloaded to the downlink point.

In another aspect, a data processing system may include, a middleware computing device including middleware, the middleware adapted to receive object data collected by a central satellite from a plurality of data-gathering satellites; a user device in communication with the middleware; and a computing cloud in communication with the middleware, and configured to receive object data from the middleware for processing.

In yet another aspect, a data transfer system may include a central satellite operatively connected to a downlink point; and a plurality of data-gathering satellites, each adapted to receive object data from a respective data source, the plurality of data-gathering satellite being operatively connected to the central satellite for transmitting the respective object data to the central satellite. The central satellite may be configured to transfer the object data collected from the plurality of data gathering satellites to the downlink point for processing by cloud computing.

In another aspect, a data transfer system may include a middleware computing device including middleware; a user device in communication with the middleware; a computing cloud in communication with the middleware; a central satellite operatively connected to a downlink point, the downlink point being operatively connected to the middleware; and a first data-gathering satellite adapted to receive object data from a first data source, the first data-gathering satellite being operatively connected to the central satellite.

In yet another aspect, a method of processing data may include providing a plurality of data gathering satellites, each of the plurality of satellites having the capability to receive object data; providing a central satellite in communication with a central computing device including middleware via a downlink, the central satellite being in communication with each of the plurality of data gathering satellites; providing a cloud computing resource operatively connected to the central computing device; receiving object data by the plurality of data gathering satellites; transmitting the object data from at least one of the plurality of data gathering satellites to the central satellite; transmitting the object data from the central satellite to the central computing device via the downlink; transmitting the object data from the central computing device to the cloud computing resource by the middleware; querying the middleware by a user; querying the cloud computing resource by the middleware in response to the user's query; processing the object data by the could computing resource in response to the middleware's query; transmitting a response from the cloud computing resource to the middleware; and transmitting the response from the middleware to the user.

The Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter

The foregoing is a summary and thus contains, by necessity, simplifications, generalization, and omissions of detail; consequently, those skilled in the art will appreciate that the summary is illustrative only arid is not intended to be in any way limiting. Other aspects, features, and advantages of the devices and/or processes and/or other subject matter described herein will become apparent in the teachings set forth herein.

### BRIEF DESCRIPTION OF THE SEVERAL VIEWS OF THE DRAWING

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings

FIG. 1 is a schematic diagram of an exemplary embodiment of a satellite routing system.

FIG. 2 is a flowchart showing the operation of an exemplary embodiment.

FIG. 3 is a schematic diagram of an exemplary embodiment of middleware.

FIG. 4 is a schematic diagram of cloud computing architecture according to an exemplary embodiment.

FIG. 5 is a schematic diagram of an exemplary computing system architecture for implementing embodiments.

FIG. 6 is a flowchart showing the operation of an exemplary embodiment.

FIG. 7 is a flowchart showing the operation of an exemplary embodiment.

FIG. 8 is a flowchart showing the operation of an exemplary embodiment.

FIG. 9 is a flowchart showing the operation of an exemplary embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, apparatus, computer programs and systems related to satellite communications that streamline the downlink process from a group of satellites so that information is efficiently delivered to a downlink location in communication with a computing device, such as a cloud computing device.

An exemplary embodiment satellite routing system 10 may enable a fast exchange of information among satellites 20, 22, 24, 26, 28 and enables fast access to organized data for a cloud computing resource 40 to complete calculations and communicate information back to an end distribution point, such as a user 50. In an embodiment, the system 10 may transfer data from a plurality of satellites 22, 24, 26, 28 to a central satellite 20 (which may also be referred to as a mother satellite). The data may be received from the central satellite 20 and organized by a middleware solution 60 and may be transmitted back and forth between the middleware 60 and a cloud computing resource 40, which may include one or more supercomputers, servers, and other devices known in the art. As an intermediary, the middleware 60 may provide appropriately formatted and packaged data to both the cloud computing system 40 and the end user devices 50.

Conventional communication systems typically fail to address a heed to gather data from multiple data sources in communication with multiple satellites. For example, widely separated data sources 72, 74, 76, 78 may gather and transmit data in fields such as, for example and without limitation, GPS position data, environmental science data, other measurement data, and medical data. Notably, data sources 72, 74, 76, 78 may be physically integrated with satellites 22, 24, 26, 28 or may merely be in communication, such as radio communication, with satellites 22, 24, 26, 28. With conventional systems having non-centralized communication and downlink capabilities, the opportunity to lower downlink costs and gain the fastest access to data for processing by supercomputing or cloud computing resources is not possible.

Exemplary embodiments of the present invention may overcome the disadvantages of conventional systems by using an inter-satellite communication system that utilizes a centralized satellite 20 which may gather data from a network of one or more surrounding satellites 22, 24, 26, 28 (which may form a comprehensive global satellite data system) with a single point of downlink 80 (such as a terrestrially located downlink facility). Each of the satellites 22, 24, 26, 28 may receive data from one or more data sources 72, 74, 76, 78, which may be onboard or remote. It is also within the scope of certain aspects of the invention that the remote data sources are other satellites. The single downlink point 80 may provide a single, high-speed, and organized data path for providing data from all of the data sources 72, 74, 76, 78 to a middleware solution 60. The middleware 60 may then channel the data to a cloud computing system 40. The cloud computing system 40 may utilize advanced computing applications to quickly produce computed data results that can be disseminated back through the middleware solution 60 to a variety of user devices 50 and interface solutions.

It is within the scope of certain aspects to utilize a satellite 22, 24, 26, 28 to receive data from more than one data source 72, 74, 76, 78, and it is within the scope of certain aspects to utilize the central satellite 20 to receive data directly from one or more of the data sources 72, 74, 76, 78. Further, it is within the scope of certain aspects to relay data from one satellite 22, 24, 26, 28 to another satellite 22, 24, 26, 28 and then to the central satellite 20.

Exemplary embodiments may employ data switching among satellites 22, 24, 26, 28 to funnel information from a group of satellites 22, 24, 26, 28 to one central satellite 20. The central satellite 20 may downlink all of the data to a downlink point 80. The downlink point 80 may then transmit the data to the middleware 60 (via a wired or wireless network, for example) so that the middleware 60 can condition the data to the specifications of the cloud 40 and forward the data on to the cloud 40. The cloud 40 may then appropriately store the data within the master database for a given application or applications resource. Such conditioning may include configuring or translating data, queries 53, or responses 55 to be compatible with a specific file type, database, application, format and/or specification.

Exemplary embodiments may transmit data among the satellites 22, 24, 26, 28 and with the central satellite 20 using available communication mechanisms such as, for example, radio, microwave, and/or laser communications systems.

In exemplary embodiments, the satellites 22, 24, 26, 28 may be programmed to forward data to the mother or central satellite 20, which may be programmed to downlink the data to a downlink facility 80 which may be terrestrially located. It is within the scope of the disclosure to program or re-program (and otherwise configure or re-configure) one or more of the satellites 20, 22, 24, 26, 28 from a ground control facility (which may be the downlink facility) and/or one or more of the satellites may be programmed prior to being placed into orbit.

Further, it is within the scope of the disclosed subject matter for the roles of the various satellites 20, 22, 24, 26, 28 to switch over time. For example, if one or more of the satellites 20, 22, 24, 26, 28 is in other than a geostationary orbit, the role of the central satellite 20 may switch from one satellite to another satellite that is in an appropriate position to communicate directly with the terrestrial downlink facility 80. Similarly, a satellite that was previously functioning as the central satellite 20 may assume the role of a data relaying satellite when another satellite serves as the central satellite 20. Further, it is within the scope of the disclosed subject matter to utilize more than one downlink facility 80. For example, if the central satellite 20 moves relative to the earth from a position proximate a first downlink facility to a position proximate a second downlink facility, the second downlink facility may serve as the downlink facility.

Exemplary embodiments may include more than one downlink 80. For example, a first downlink may be operatively connected to a first middleware and a second downlink may be operatively connected to a second middleware. Data pertaining to a first subject may be transmitted among the satellites and downlinked via the first downlink, which may transfer the data to a cloud computing resource 40 via the first middleware. Data pertaining to a second subject may be transmitted among satellites and downlinked via the second downlink, which may transfer the data to a cloud computing resource via the second middleware. Particularly for satellite transmissions carrying time sensitive data, these techniques can be invaluable to the cloud system allowing for quicker computations and modeling resources that can then be disseminated by the middleware infrastructure and distributed back to users, with fully compatible data translations via the middleware, to the users' 50 devices.

Exemplary cloud computing resources 40 may include applications, platforms, raw computing power and storage, and managed services delivered via a network, such as the internet. The cloud computing resource 40 may include one or more servers which may utilize one or more virtual servers to provide services to users. Further, a cloud computing resource 40 may include one or more supercomputing devices.

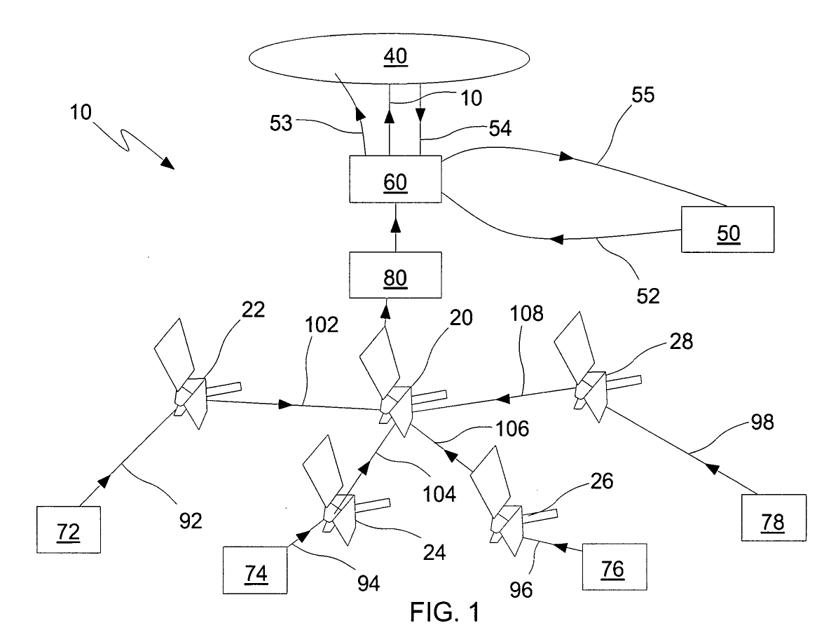

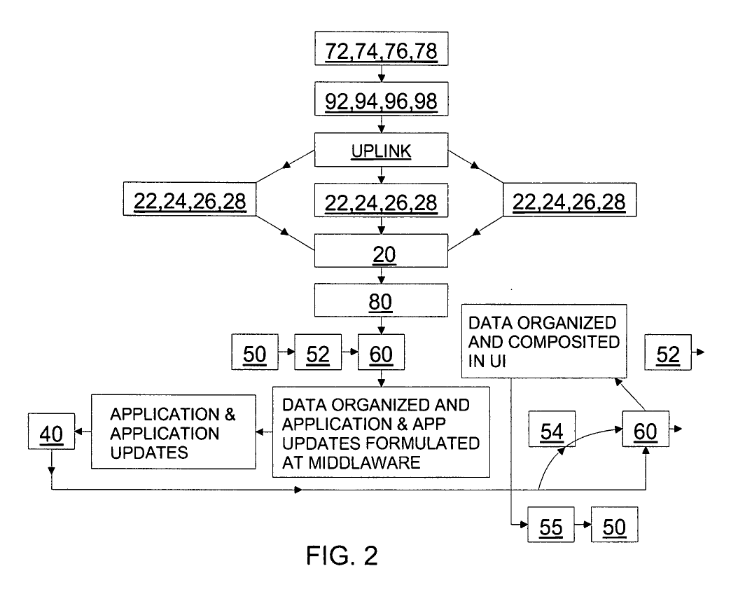

Exemplary middleware 60 (which may run on a central computing resource, such as one or more servers) may operate as an interface between the cloud 40 and its inputs and outputs. For example, as shown in FIGS. 1 and 2, the middleware 60 may receive a query 52 from a user 50. The middleware 60 may send one or more appropriately formatted and addressed queries 53 to the cloud 40. After performing the specified task or tasks, the cloud 40 may send one or more responses 54 to the middleware 60. The middleware 60 may receive and, if necessary, interpret or reformat the responses 54 corresponding to the query 53, where the data may be organized and composited in a user interface (UI). The middleware 60 may then transmit a response 55 to the user 50. The response 55 may, for example, be formatted by the middleware 60 for appropriate display on the user's 50 device (having the appropriate UI), such as a desktop computer, a mobile or handheld device, etc. Further, the middleware 60 may appropriately format the response 55 for the user's 50 operating system and/or user interface.

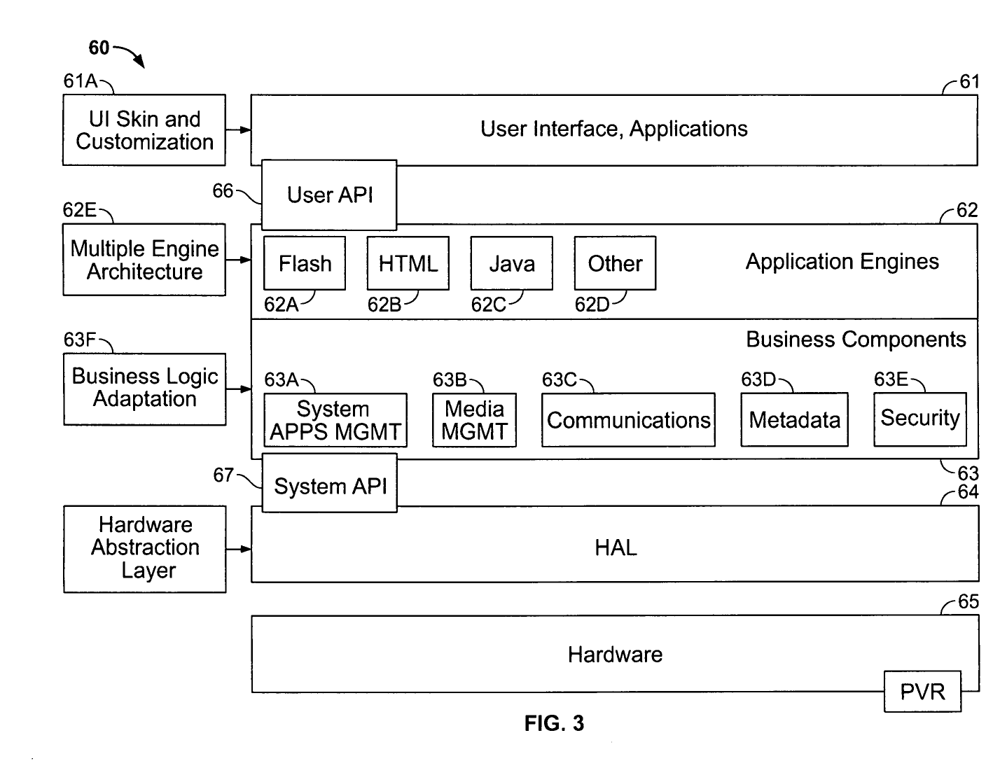

As shown in FIG. 3, exemplary middleware 60 architecture may include components such as user interface application 61, application engines 62, business components 63, a hardware abstraction layer 64, and hardware 65. The user interface applications 61 may include user interface skin and other customization 61A. A user application programming interface (API) 66 may link the user interface applications 61 with the application engines 62. The application engines 62 may include multiple engine architecture 62E, such as Flash 62A, HTML 62B, Java 62C, or other languages 62D. The business components 63 may include system and applications management 63A, media management 63B, communications 63C, metadata 63D, and security 63E and may incorporate business logic adaptation 63F. A system application programming interface (API) 67 may link the business components with the hardware abstraction layer 64.

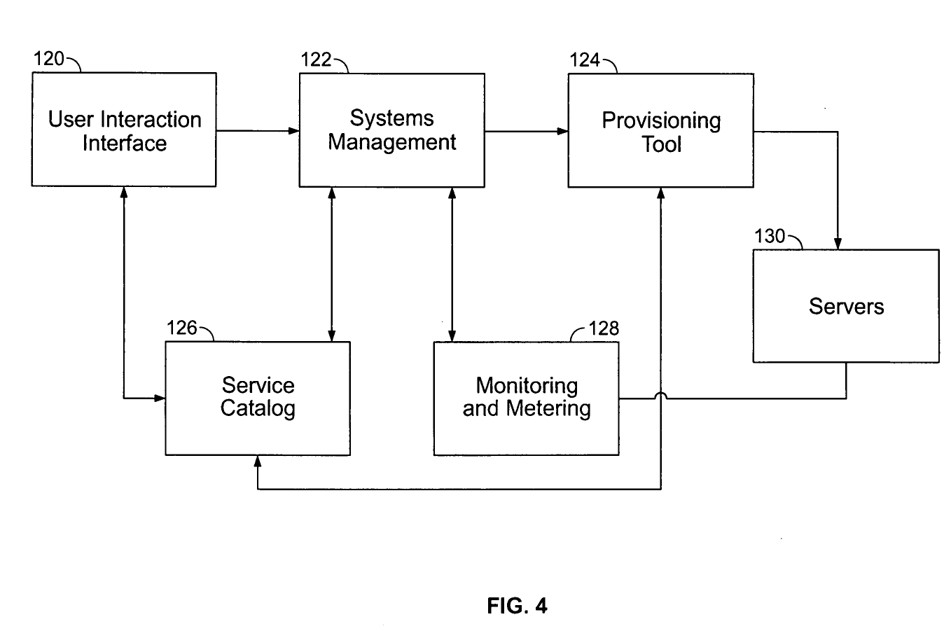

As shown in FIG. 4, exemplary cloud computing architecture may include a user interaction interface 120, systems management component 122, a provisioning tool 124, a service catalog 126, monitoring and metering components 128, and servers 130, which may include one or more servers and/or one or more virtual servers. The user interaction interface may interact with the system management component 122 and the service catalog 126. The systems management component 122 may interact with the user interaction interface 120, the service catalog 126, the monitoring and metering components 128, and the provisioning tool 124. The provisioning tool 124 may interact with the system management component 122, the service catalog 126, and the servers 130. The servers 30 may interact with the provisioning tool 124 and the monitoring and metering components 128. The monitoring and metering components 128 may interact with the systems management component 122 and the servers 130. The service catalog 126 may interact with the user interaction interface 120, the systems management component 122, and the provisioning tool 124.

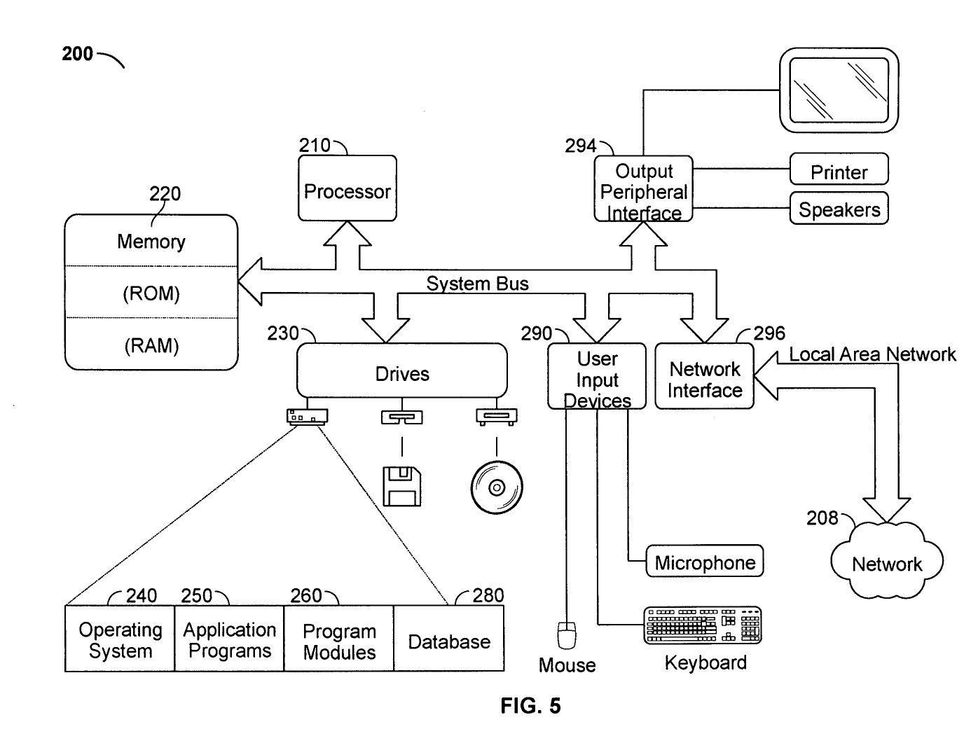

With reference to FIG. 5, depicted is an exemplary computing system for implementing embodiments. FIG. 5 includes a computer 200, including a processor 210, memory 220 and one or more drives 230. The drives 230 and their associated computer storage media, provide storage of computer readable instructions, data structures, program modules and other data for the computer 200. Drives 230 can include an operating system 240, application programs 250, program modules 260, and database 280. Computer 200 further includes user input devices 290 through which a user may enter commands and data. Input devices may include an electronic digitizer, a microphone, a keyboard and pointing device, commonly referred to as a mouse, trackball or touch pad. Other input devices may include a joystick, game pad, satellite dish, scanner, or the like.

These and other input devices can be connected to processor 210 through a user input interface that is coupled to a system bus, but may be connected by other interface and bus structures, such as a parallel port, game port or a universal serial bus (USB). Computers such as computer 200 may also include other peripheral output devices such as speakers, which may be connected through an output peripheral interface 294 or the like.

Computer 200 may operate in a networked environment using logical connections to one or more computers, such as a remote computer connected to network interface 296. The remote computer may be a personal computer, a server, a router, a network PC, a peer device or other common network node, and can include many or all of the elements described above relative to computer 200. Networking environments are commonplace in offices, enterprise-wide area networks (WAN), local area networks (LAN), intranets and the Internet. For example, in the subject matter of the present application, computer 200 may comprise the source machine from which data is being migrated, and the remote computer may comprise the destination machine or vice versa. Note however, that source and destination machines need not be connected by a network 208 or any other means, but instead, data may be migrated via any media capable of being written by the source platform and read by the destination platform or platforms. When used in a LAN or WLAN networking environment, computer 200 is connected to the LAN through a network interface 296 or an adapter. When used in a WAN networking environment, computer 200 typically includes a modem or other means for establishing communications over the WAN, such as the Internet or network 208. In light of the present disclosure, it will be appreciated that other means of establishing a communications link between the computers may be used.

According to one embodiment, computer 200 is connected in a networking environment such that the processor 210 and/or program modules 260 can perform with or as a computing system for middleware communicating with a cloud computing resource in accordance with embodiments herein.

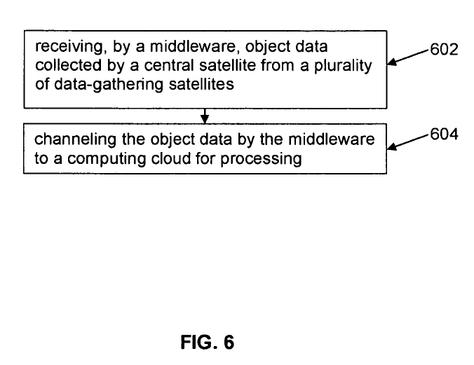

In one exemplary embodiment (as shown in FIG. 6), a method for processing data gathered by satellites may include receiving 602, by a middleware, object data collected by a central satellite from a plurality of data-gathering satellites; and channeling 604 the object data by the middleware to a computing cloud for processing.

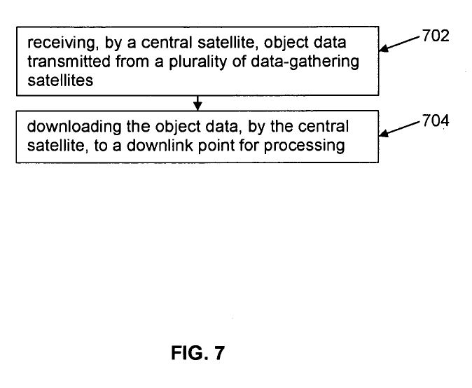

In one exemplary embodiment (as shown in FIG. 7), a method for processing data utilizing satellites may include receiving 702, by a central satellite, object data transmitted from a plurality of data-gathering satellites; and downloading 704 the object data, by the central satellite, to a downlink point for processing.

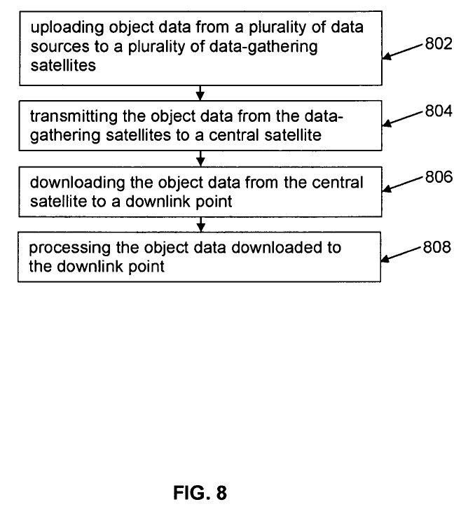

In another exemplary embodiment (as shown in FIG. 8), a method for processing data utilizing satellites may include uploading 802 object data from a plurality of data sources to a plurality of data-gathering satellites; transmitting 804 the object data from the data-gathering satellites to a central satellite; downloading 806 the object data from the central satellite to a downlink point; and processing 808 the object data downloaded to the downlink point.

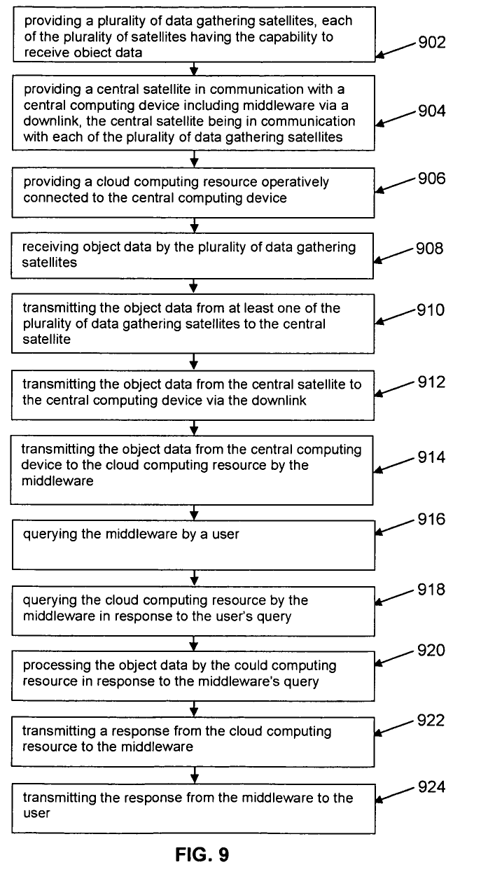

In yet another exemplary embodiment (as shown in FIG. 9), a method of processing data may include providing 902 a plurality of data gathering satellites, each of the plurality of satellites having the capability to receive object data; providing 904 a central satellite in communication with a central computing device including middleware via a downlink, the central satellite being in communication with each of the plurality of data gathering satellites; providing 906 a cloud computing resource operatively connected to the central computing device; 908 receiving object data by the plurality of data gathering satellites; transmitting 910 the object data from at least one of the plurality of data gathering satellites to the central satellite; transmitting 912 the object data from the central satellite to the central computing device via the downlink; transmitting 914 the object data from the central computing device to the cloud computing resource by the middleware; querying 916 the middleware by a user; querying 918 the cloud computing resource by the middleware in response to the user's query; processing 920 the object data by the could computing resource in response to the middleware's query; transmitting 922 a response from the cloud computing resource to the middleware; and transmitting 924 the response from the middleware to the user.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies, are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together; and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and G together, and/or A, B, and C together, etc;). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for processing data gathered by satellites, comprising:
receiving, by a middleware, object data collected by a central satellite from a plurality of data-gathering satellites; and
channeling the object data by the middleware to a computing cloud for processing.

2. The method of claim 1, further comprising conditioning the object data by the middleware prior to, or during channeling the object data to the computing cloud.

3. The method of claim 2, wherein conditioning the object data by the middleware includes at least one of:
organizing the object data;
formatting the object data; and
packaging the object data.

4. The method of claim 1, wherein the middleware receives the object data from a terrestrial downlink point.

5. The method of claim 4, further comprising transmitting information to a user device based upon a result of channeling the object data.

6. The method of claim 5, wherein transmitting information to a user device is performed utilizing the middleware.

7. The method of claim 6, wherein transmitting information to the user device follows receiving, by the middleware, a query for information from the user device.

8. The method of claim 6 further comprising formatting the information by the middleware appropriate for receipt by the user device.

9. The method of claim 1, wherein the object data is taken from a group consisting of GPS position data, environmental science data, and medical data.

10. The method of claim 1, further comprising selecting the middleware from two or more available middleware.

11. The method of claim 10, wherein selecting the middleware is based, at least in part, upon the subject of the object data.

12. A method for processing data utilizing satellites, comprising:
receiving, by a central satellite, object data transmitted from a plurality of data-gathering satellites; and
downloading the object data, by the central satellite, to a downlink point for processing.

13. The method of claim 12, wherein receiving object data utilizes intra-satellite communications.

14. The method of claim 12, further comprising selecting the downlink point from two or more available downlink points.

15. The method of claim 14, wherein selecting a downlink point from two or more available downlink points is based, at least in part upon the subject of the object data.

16. The method of claim 12, further comprising:
prior to at least downloading the object data, designating, by the central satellite, to be responsible for performing the downloading based, at least in part, upon the location of the central satellite with respect to at least one other satellite.

17. The method of claim 16, wherein the designating is based, at least in part, upon the locations of the central satellite and the at least one other satellite with respect to a terrestrial downlink point.

18-37. (canceled)

38. A data processing system:
a middleware computing device including middleware, the middleware adapted to receive object data collected by a central satellite from a plurality of data-gathering satellites;
a user device in communication with the middleware; and
a computing cloud in communication with the middleware, and configured to receive object data from the middleware for processing.

39. The data processing system of claim 38, wherein the object data received by the computing cloud has been configured by the middleware prior to receipt by the computing cloud.

40. The data processing system of claim 38, wherein the object data is taken from a group consisting of GPS position data, environmental science data, and medical data.

41. The data processing system of claim 38, further comprising a downlink operatively connected between the central satellite and the middleware for communicating the object data from the central satellite to the middleware.

42. The data processing system of claim 38, wherein the computing cloud includes a plurality of servers accessible by the middleware.

43. A data transfer system comprising:
a central satellite operatively connected to a downlink point; and
a plurality of data-gathering satellites, each adapted to receive object data from a respective data source, the plurality of data-gathering satellite being operatively connected to the central satellite for transmitting the respective object data to the central satellite;
the central satellite being configured to transfer the object data collected from the plurality of data gathering satellites to the downlink point for processing by cloud computing.

44. The data transfer system of claim 43, wherein the data-gathering satellites are operatively connected to the central satellite by a laser data transfer device.

45. The data transfer system of claim 43, wherein the data sources are terrestrial.

46. The data transfer system of claim 43, further comprising a terrestrial downlink.

47. The data transfer system of claim 43, wherein the central satellite is configured to select the downlink point from two or more available downlink points.

48. The data transfer system of claim 47, wherein the central satellite is configured to select the downlink point from two or more available downlink points based, at least in part upon the subject of the object data.

49. The data transfer system of claim 43 wherein at least one of the data gathering satellites is configured to act as a central satellite under predetermined circumstances.

50. The data transfer system of claim 49, wherein the predetermined circumstances include the position of the central satellite and the at least one data gathering satellite with respect to the downlink point.

51. The data transfer system of claim 49, wherein the predetermined circumstances include the subject of the object data.

52-71. (canceled)
